(19) United States
(12) Patent Application Publication
(10) Pub. No.: US 2015/0379846 A1
(43) Pub. Date: Dec. 31, 2015

(54) Detector With Optical Block

(71) Applicant: Honeywell International Inc., Morristown, NJ (US)

(72) Inventors: Massimo Bressanutti, Sesto al Reghena (IT); Mauro Miheli, Trieste (IT); Andrea Chiatti, Trieste (IT)

(21) Appl. No.: 14/315,636

(22) Filed: Jun. 26, 2014

(51) Int. Cl. G08B 17/107

(52) U.S. Cl. CPC G08B 17/107

(57) ABSTRACT

An optical smoke detector includes a radiant energy source and a sensor. The source and sensor are carried by an optical block which provides a fixed orientation therebetween and barriers therebetween. The barriers reduce noise and false alarming due to bugs, dust water vapor and other intrusive elements. The barriers can include V-shaped members at a selective angle relative to center lines of the source and sensor.

### FIELD

The application pertains to optically based smoke detectors. More particularly, the application pertains to such detectors which provide improved signal-to-noise ratios through the use of selectively configured optical blocks.

### BACKGROUND

Various types of optical, scattering, smoke detectors are known. They provide useful warnings of developing smoke conditions. One such structure is disclosed in U.S. Pat. No. 6,521,907, entitled, “Miniature Photoelectric Sensing Chamber”, issued Feb. 18, 2003 and assigned to the Assignee hereof. The '907 patent is incorporated by reference herein.

In summary, optical smoke detectors or multi-criteria smoke detectors, which use an optical signal to detect fires, include a sensing chamber where smoke enters, an optical system to detect light scattered by smoke particulate, possibly other transducers (thermistors, etc.) and an electronic control circuits and a communication system to process signals from transducers. Information from the detector can be transmitted to a fire alarm control panel (some types of detectors do not communicate with a control panel but have an integrated alarm system).

In known smoke, fire, detectors, the optical system includes an optical emitter and a receiver which are integrated with the sensing chamber of the detector through the use of an optic part holder. Among other functions, this part holder facilitates automatic assembly of the detector.

The optical system has to meet various needs and requirements to be suitable for its purpose. Known needs and requirements can include acceptable optical sensitivity to guarantee a good signal to noise ratio in the presence of smoke; immunity to small non-smoke particulate matter or bugs that enter the sensing chamber; and immunity to condensation and humidity.

Small size due to reduced chamber volume is an asset as is the ability to cost effectively assembly such detectors using automatic placement machines.

As those of skill will understand, the optical emitters and receivers have to be located so that, without smoke, only a very little amount of light reaches the receiver after multiple reflections in the sensing chamber. On the other hand, in the presence of smoke, a sufficient amount of light projected by the emitter is scattered by smoke particles and collected by the optical receiver so that the presence of smoke can be evaluated.

It has also been recognized that a variety of interfering phenomena can adversely impact the performance of such devices. These include dust, insects or small objects which can enter the sensing chamber and cause a signal drift or false alarms. High humidity or condensation phenomena in the sensing chamber can also effect unwanted signal variations.

Different configurations of the optical systems in commercial fire detectors are known. The emitters and receivers can be soldered to a printed circuit board. The optical set-up is assured through the use of one or more molded optic part holders. The optic part holder can also reduce the light beam from the emitter, in order to get a larger optical signal only in the presence of smoke in the sensing chamber.

### BRIEF DESCRIPTION OF THE DRAWINGS

FIG. 1 is a side sectional view of a smoke detector in accordance herewith;

FIG. 2 is a perspective view of an optical block as in the detector of FIG. 1;

FIG. 3 is a sectional view of the optical block of FIG. 2;

FIG. 4 is a side view of the optical block of FIG. 2;

FIG. 5 is a sectional view of the optical block of FIG. 4;

FIG. 6 is a top view of the optical block of FIG. 4;

FIG. 7 is an end view of the optical block of FIG. 4;

FIG. 8 is a top view of the block illustrating pick-and-place areas for automatic assembly;

FIG. 9 is a side sectional view of the block of FIG. 8;

FIG. 10 is a perspective view of the block with a metal shield removed;

FIG. 11 is a side view of an alternate optical block in accordance herewith;

FIG. 12 is a top plan view of the optical block of FIG. 11;

FIG. 13 is an emitter end view of the optical block of FIG. 11;

FIG. 14 is a sectional view taken along plane 14-14 of FIG. 12;

FIG. 15 is a perspective view of the optical block of FIG. 11;

FIG. 16 is a sectional view taken along plane 16-16 of FIG. 12;

FIG. 17 is a perspective view of a single ended optical block;

FIG. 18 is a side view of the block of FIG. 17;

FIG. 19 is a top plan view of the block of FIG. 17;

FIG. 20 is a side sectional view of the block of FIG. 17 taken along plane 20-20 of FIG. 19;

FIG. 21 is an end view of the block of FIG. 17;

FIG. 22 is a perspective view of a barrier only optical block;

FIG. 23 is a top plan view of the block of FIG. 22;

FIG. 24 is a side view of the block of FIG. 22;

FIG. 25 is an end view of the block of FIG. 22.

### DETAILED DESCRIPTION

While disclosed embodiments can take many different forms, specific embodiments hereof are shown in the drawings and will be described herein in detail with the understanding that the present disclosure is to be considered as an exemplification of the principles hereof, as well as the best mode of practicing same, and is not intended to limit the claims hereof to the specific embodiment illustrated.

Embodiments hereof, advantageously use an elongated optical block which is described below. In this molded optical block, the central portion provides spaced apart, emitter and the receiver zones. In a disclosed embodiment, two mirror-like V-shaped barriers—one nearer the emitter, the “emitter barrier”, and one closer to the receiver, the “receiver barrier” face one another.

The emitter barrier is directly illuminated by the emitter. Small objects that could enter the chamber through an inflow filter settle on its upper surface, and scatter light. However, this light is intercepted by the receiver barrier. On the other hand, small objects, or water droplets that settle on the receiver barrier are not directly illuminated by the emitter because they are under the shadow of the emitter barrier.

The two barriers are separated by a lower plane. The two barriers and the lateral sides form a small basin, or depression, which can contain small objects that enter the chamber filter or condensed water drops. This feature can prevent significant output signal variations.

The resulting effect is that condensation, dust, insects or other small objects that could settle on the optic block do not cause a significant increase in the output optical signal.

As described below, the distance between the two barriers and their geometry are such as to maximize optical sensitivity and provide immunity to condensation, dust, insects and other small objects that could enter the sensing chamber.

Four flat pick-up areas are provided on the optical block for the automatic placement of the block. Various pick-up processes are available for the automatic placement of the block. It is also possible to pick the optical block up with two different nozzles that aspire the optic block through the upper or lower pick-up regions. It will be understood that the exact manufacturing process is not a limitation hereof.

The upper pick-up areas are bounded by two steps. As a result, drops, formed by humidity condensation in these areas, do not interfere with the emission radiation cone thereby causing output signal variations.

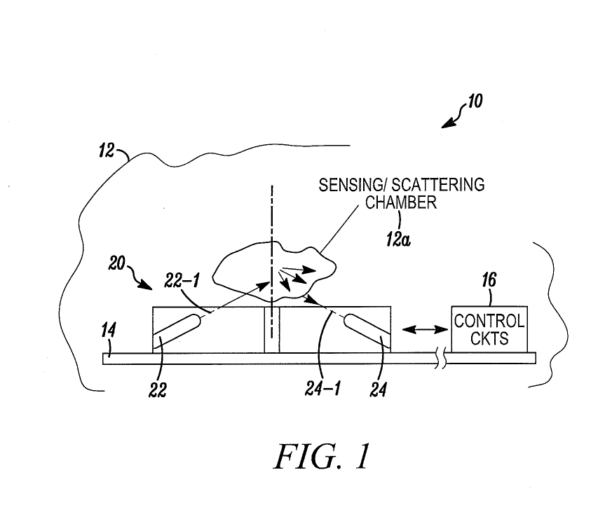

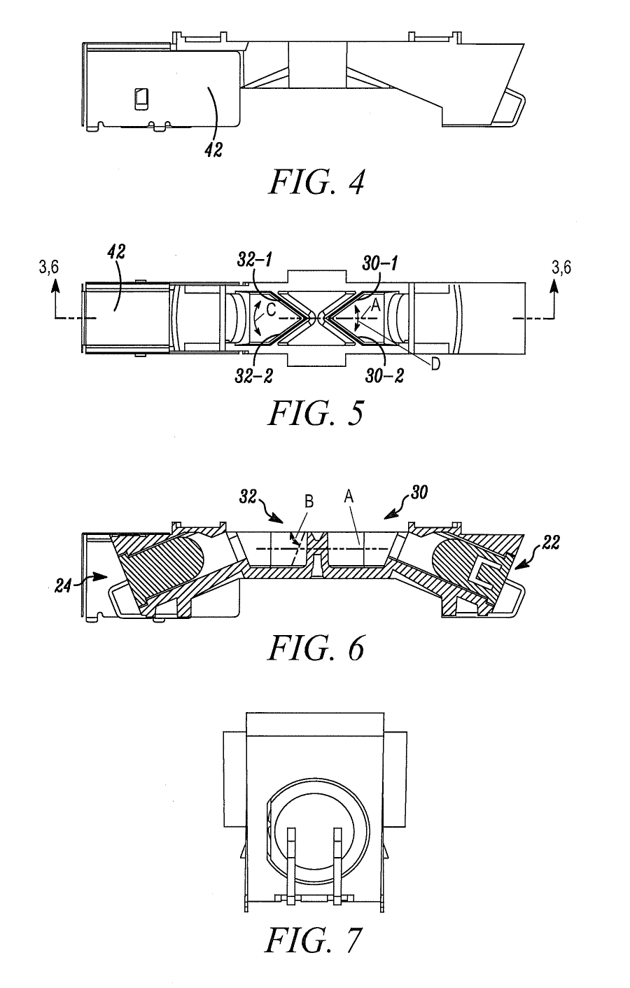

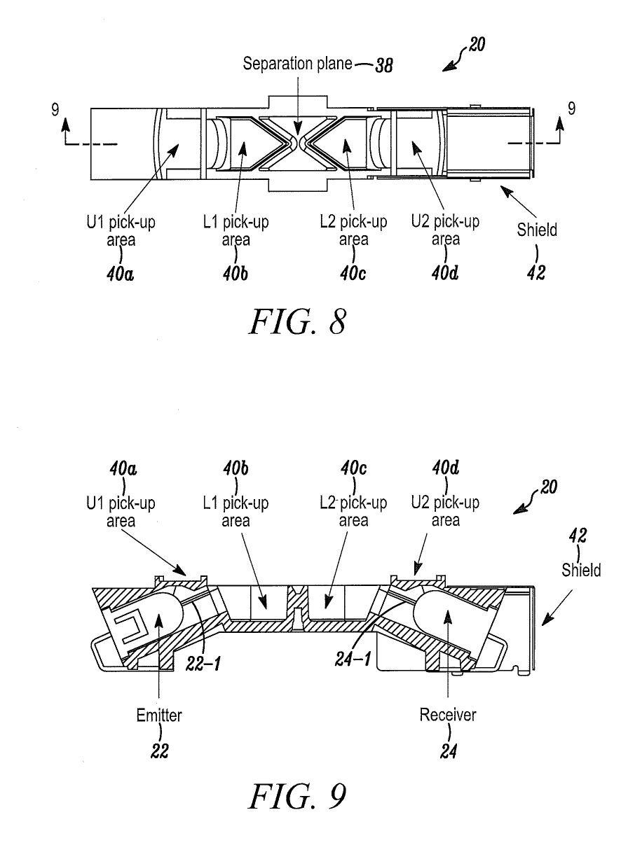

FIGS. 1-9 illustrate various views of a smoke detector and an optical block in accordance herewith. In FIG. 1 a scattering, or diffraction-type, smoke detector 10 is illustrated. The detector 10 includes an external housing 12 which carries a planar support member 14, which could be implemented as a printed circuit board 14. Control circuits 16, carried by member 14 are coupled to an optical block 20.

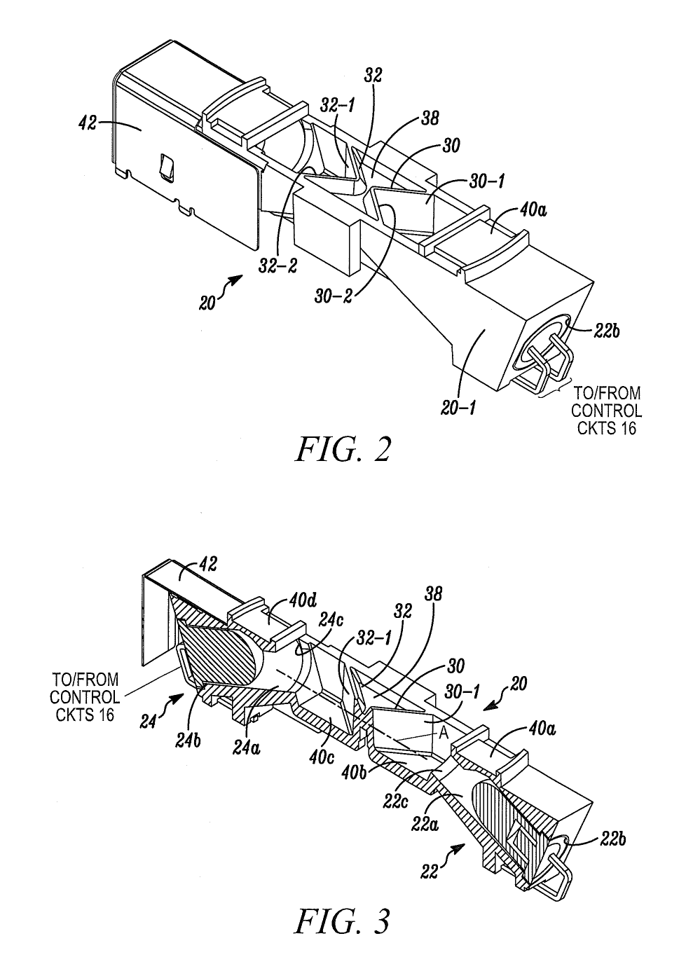

With respect to FIGS. 2-9, optical block 20, has a molded body member 20-1, and includes molded channels 22a, 24a which receive the emitter 22, via input port 22b, and receiver, sensor, 24 via input port 24b. The emitter 22 and sensor 24 have respective center lines 22-1 and 24-1 which extend from the block 20 toward an adjacent sensing chamber 12a.

Emitted radiant energy from emitter, a light emitting or laser diode, 22 exits channel 22a via output port 22c. Scattered radiant energy, from sensing chamber 12a travels via input port 24c to receiver 24 where it is sensed and coupled to control circuits 16 as would be understood by those of skill in the art.

A V-shaped emitter barrier 30 has two planar side surfaces 30-1, -2. A V-shaped receiver barrier 32 has two planar side surfaces 32-1, -2. The barriers 30, 32 are located displaced from respective ports 22c, 24c along a center line A of the block 20.

The emitter barrier 30 is directly illuminated by the emitter 22 which is intermittently energized by the control circuits 16. Small objects, dust, drops of water due to humidity and temperature changes, or bugs, that might enter the sensing chamber 12a through an input filter, not shown, might settle on an upper surface and scatter light. Such scattered light will be intercepted by the receiver barrier 32 and not contribute to locally generated noise. Advantageously, such objects that settle on the receiver barrier 32 are not directly illuminated because they are under the shadow of the emitter barrier 30.

A depressed separation plane 38 provides a region into which such objects, including water drops, can fall; this plane directs them away from either the radiant energy from the source 22 or that arriving at receiver 24.

An optical sensitivity and immunity ratio can be adjusted to provide desirable optical sensitivity and good immunity to dust, condensation and small objects that might settle on the block 20 by providing an emitter angle on the order of seventy degrees plus/minus twenty five degrees. A receiver angle can be adjusted accordingly. The receiver angle can vary from seventy degrees between plus one hundred ten degrees (straight barrier) and minus twenty five degrees.

Molding the barrier surfaces, such as 30-1,-2, 32-1, -2 so that substantially vertical barrier planes are formed is effective in avoiding the settling of non-smoke particulate matter on the edge of the barriers. This minimizes false alarms and output signal drifts. A slope between ninety degrees, relative to the axis A and sixty degrees provides acceptable noise immunity.

A plurality of pick-and-place areas 40a, b, c, d can also be provided to facilitate pick and place operations during an automatic assembly process. A U-shaped metal shield 42 can be attached to the receiver end of the block 20. This shield can partially enclose receiver 24 isolating it from local noise generating electromagnetic waves. FIG. 6 includes a central axis A of the block 20.

While a variety of angular settings come within the scope and spirit hereof, with respect to FIGS. 5, 6 angle B, the barrier plane slope, is preferably in a range of sixty degrees to ninety degrees. Angle C is in a range of one hundred ten degrees to forty five degrees. Angle D is in the range of ninety five degrees to forty five degrees. Most preferably, angle B will be set on the order of ninety degrees, and, angles C and D will be set on the order of seventy degrees.

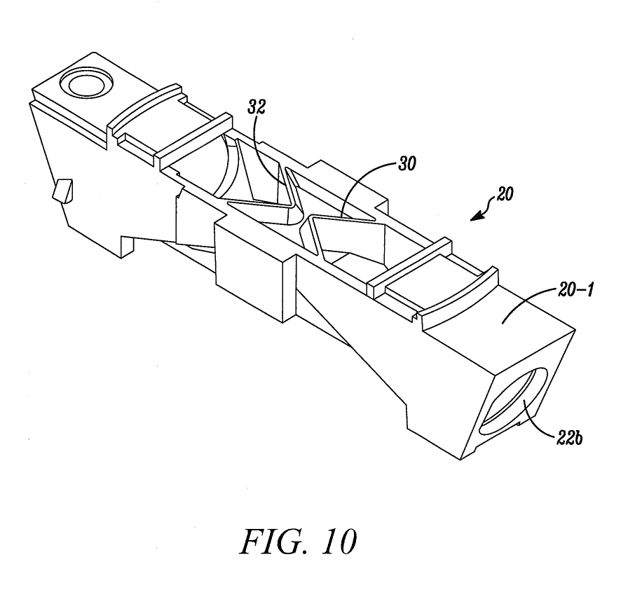

FIG. 10 illustrates the block 20 with the shield 42 removed. While a shield has been illustrated in connection with the receiver 24, it will be understood that a shield could also be used with emitter 22. Alternately, shield 42 could be omitted as illustrated in FIG. 10. It will be understood that neither the shield 42, nor its absence are limitations hereof.

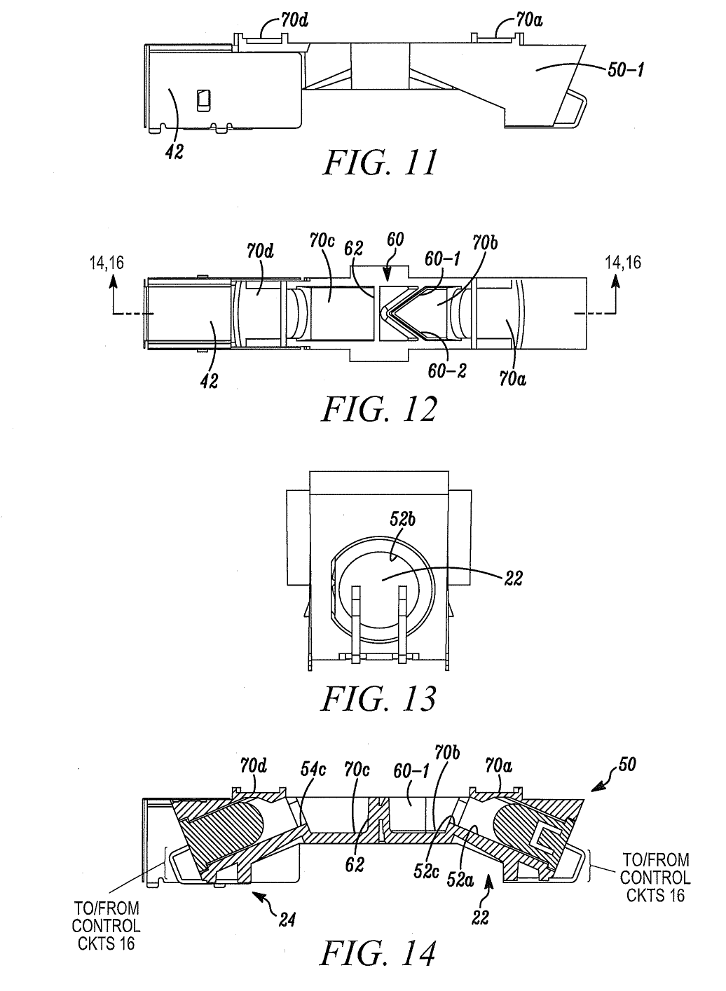

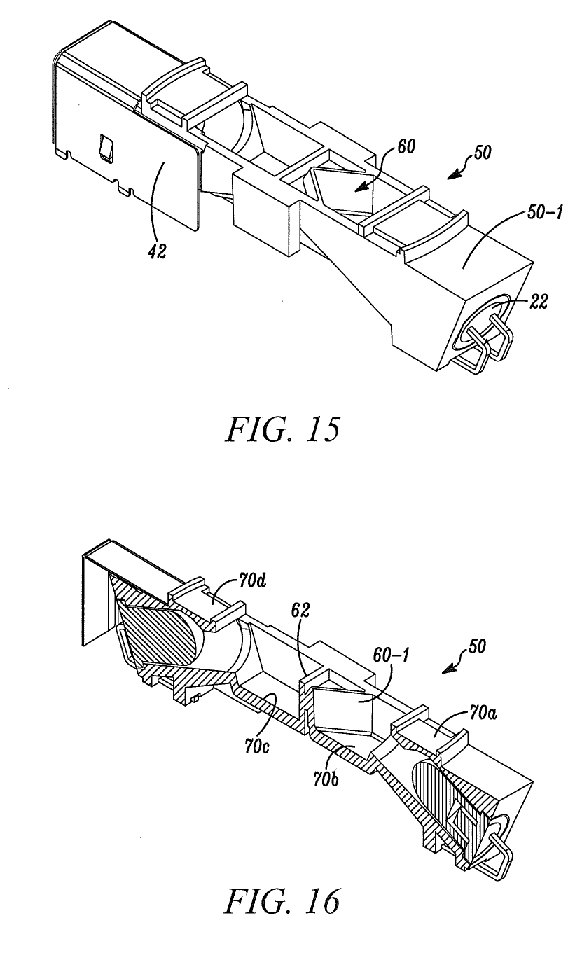

FIGS. 11-16 illustrate various aspects of an alternate form of optical block 50. Elements previously, described, which appear in FIGS. 11-16 have been assigned the same identification numerals and need not be described further.

Optical block 50 is substantially the same as optical 20 except that the block 50 includes only a single V-shaped barrier/reflector combination 60. Barrier element 60 has planar surfaces 60-1, -2 arranged in the same configuration as previously described in connection with barrier element 30. Instead of a second V-shaped barrier element, the block 50 includes a planar surface 62, see FIG. 12 hereof.

The emitter 22 can be located on the side of block 50 with the barrier 60. The surface 62 can be located on the side of the block 50 associated with receiver 24.

Planar pick surfaces 70a, b, c and d are located on the block 50 as illustrated. The surface 62 is oriented so as to be substantially perpendicular to the adjacent planar pick surface 70c. Alternately, the barrier element 60 could be located adjacent to the receiver 24.

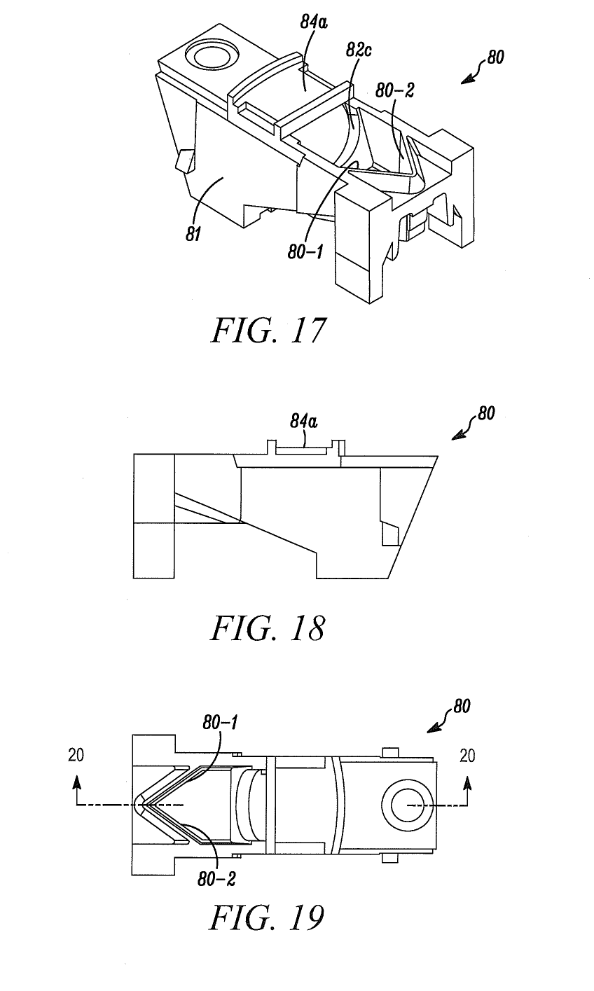

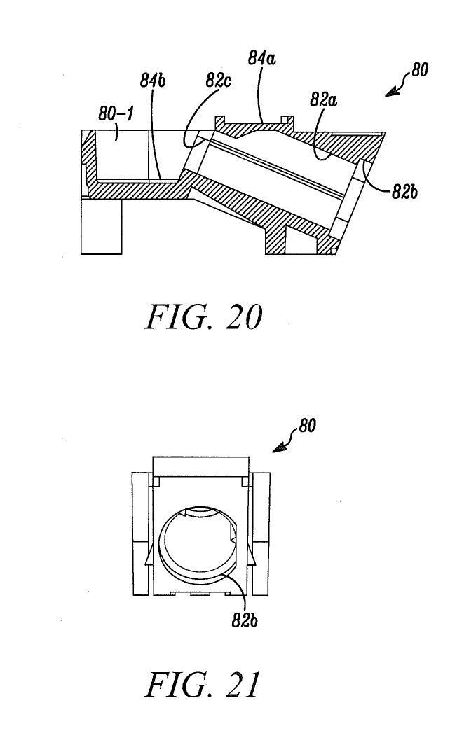

FIGS. 17-21 illustrate a single ended alternate embodiment of an optical block 80. The block 80 has a body portion 80-1 with a channel 82a, input port 82b and output port 82c which can receive one of the emitter 22 or receiver 24. A single barrier and reflector element 80-1, -2 comparable to the element 30, previously discussed, is formed in the body 80-1.

A pair of separate optical blocks, such as the block 80 could be mounted on a base adjacent to a sensing chamber to form a smoke detector of the general type discussed above.

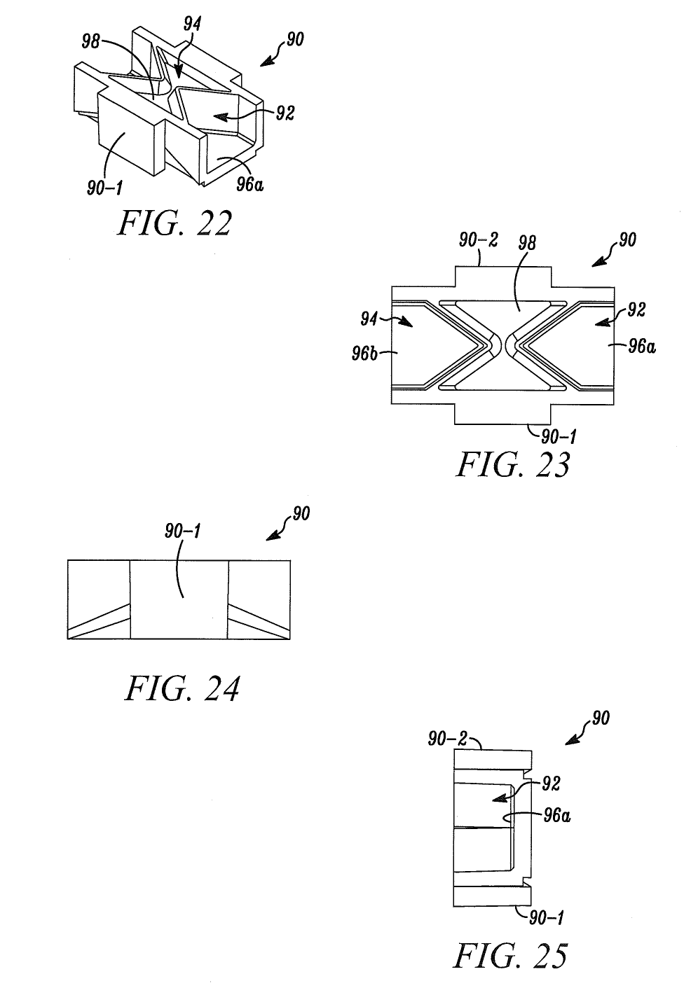

FIGS. 22-25 illustrate various views of a stand-alone modular barrier 90. The barrier 90 includes two molded barriers 92, 94 of the type previously discussed. A depressed region 98 is provided therebetween to collect dust, insects or condensed drops of water generally as described above with respect to block 20. The barrier 90 could be located between an emitter and a receiver to reduce the emitted light beam and to avoid direct illumination of the respective receiver.

In summary, the optical barriers described above can be molded of thermoplastic or thermosetting molding materials. A low cost mineral reinforced nylon resin, which can be injection molded by the application of heat and pressure to form parts with good mechanical properties, can be effectively used to manufacture the above described optical blocks.

The optic part block can carry and position optical emitters and receivers with a 5 mm (T 1¼) package, whose leads can be bent to facilitate an automatic mounting process of the optical block. The optic block can be scaled to use optical emitters and receivers with a 3 mm package.

Optic blocks as describe above are designed to be mounted on a support member, such as a printed circuit board using standard assembly processes.

Optic blocks as described above can be supplied in a tape and reel assembly in a dedicated feeder. The optical blocks can be fed to an automatic placement machine for mass production.

The mounting process can include different stages including; pick-up, a vacuum nozzle collects the optic block from a pick-up area, a first vacuum check can be made to determine if the block has been pick-up correctly. A camera inspection can be carried out. If the previous check passes, a camera can measure the optic block and calculate any offset needed to place the component precisely. The block can be moved to the printed circuit board. A second vacuum check can be carried out to verify that the component is still on the nozzle. The optical block can be placed on the printed circuit board. The optic block can be directly mounted on the printed circuit board.

The emitter can be connected to a driver circuit that pulses it in order to generate light that can be projected into the sensing chamber. Some of that light is scattered by smoke particles onto the receiver, triggering an alarm signal.

The optic blocks as described above, and the sensing chamber are designed so that, without smoke, only a small amount of light from the emitter is scattered toward the receiver, compared to the amount of light scattered by smoke entering during a fire.

To complete the assembling process of the fire detector, the printed circuit board with the optic block is inserted between the detector base and the plastic parts that form the sensing chamber. Finally the sensing chamber can be bounded by a cover which might also carry an air inflow filter. The cover conveys smokes into the sensing chamber.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be add to, or removed from the described embodiments.

1. A detector comprising:
a source which emits a beam of radiant energy toward a sensing chamber when energized;
a sensor which responds to incident radiant energy from the sensing chamber; and
an optical support member which carries at least one of the source or sensor wherein the member provides at least one optical barrier which blocks at least a portion of the beam or the incident radiant energy.

2. A detector as in claim 1 where the at least one optical barrier comprises first and second elongated planar segments positioned on the member so as to block, in part, the emitted beam or incident radiant energy.

3. A detector as in claim 2 wherein the segments are joined to form a V-shaped barrier.

4. A detector as in claim 1 where the support member includes a second optical barrier with one associated with the source, and the other associated with the sensor.

5. A detector as in claim 4 where portions of the member between the source and sensor are substantially symmetrical.

6. A detector as in claim 4 which carries an electrical shield adjacent to the sensor.

7. A detector as in claim 1 which includes a housing which carries the optical support member, the source and the sensor and which defines an internal sensing region to which radiant energy from the source is directed, and from which scattered radiant energy is incident on the sensor.

8. A detector as in claim 7 where the slope of the barrier plane is oriented at an angle substantially on the order of ninety degrees relative to a planar pick surface of one of the source or the sensor.

9. A detector as in claim 8 where the angle is in a range on the order of ninety degrees, minus thirty degrees

10. A detector as in claim 3 where the surfaces are on the order of seventy degrees, plus or minus twenty five degrees for the emitter barrier and plus one hundred and ten or minus twenty five degrees for the receiver barrier relative to one another.

11. A detector as in claim 10 which includes first, and second spaced apart planar pick surfaces.

12. A detector as in claim 11 which includes a metallic shield which, in part, surrounds the sensor.

13. A detector comprising:
a molded module having first and second spaced apart end portions with at least one end portion exhibiting first and second planar surfaces that are joined at a common line, the surfaces receive incident radiant energy, and in part, block same.

14. A detector as in claim 13 where the planar surfaces on each end portion are joined along the common line to form a V-shaped barrier.

15. A detector as in claim 14 which includes a source directed to one barrier and a receiver directed toward another barrier.

16. A detector as in claim 15 where the module receives at least one of a beam or scattered incident radiant energy and wherein the barriers block a portion of the beam or the scattered incident radiant energy.

17. A detector as in claim 16 where the planar surfaces are oriented at an angle on the order of seventy degrees relative to one another.

18. A detector comprising;
an optical support block which has an emitter zone and a receiver zone with a central section therebetween, the central section includes two spaced apart barriers, one oriented to receive radiant energy from the emitter zone, the other oriented to receive radiant energy scattered toward the receiver zone, with the barriers oriented at an angle in a range of ninety degrees minus thirty degrees with respect to a selected planar surface.

19. A detector as in claim 18 wherein the barriers each include first and second planar members located at an angle on the order of seventy degrees plus or minus twenty five degrees relative to one another.

20. A detector as in claim 19 where the central section includes a recess between the barriers.
